(19) United States
(12) Patent Application Publication
(10) Pub. No.: US 2015/0156153 A1
(43) Pub. Date: Jun. 4, 2015

(54) COLLABORATIVE E-MAIL

(71) Applicants: Thomas Deselaers, Zurich (CH); Daniel Martin Keysers, Stallikon (CH)

(72) Inventors: Thomas Deselaers, Zurich (CH); Daniel Martin Keysers, Stallikon (CH)

(73) Assignee: GOOGLE INC., Mountain View, CA (US)

(21) Appl. No.: 13/476,345

(22) Filed: May 21, 2012

(51) Int. Cl. H04L 12/58; G06F 15/16

(52) U.S. Cl. CPC H04L 51/16; H04L 51/22

(57) ABSTRACT

A collaborative e-mail technique can include receiving, at a computing device in communication with a network, a collaborative e-mail request for a plurality of senders. A draft of a collaborative e-mail can be stored at a database in communication with the computing device. The plurality of senders can be notified of the collaborative e-mail request and can be provided access to the draft via the computing device. Approval of the draft can be received from the plurality of senders at the computing device and the collaborative e-mail can be sent, via the computing device, to a recipient from the plurality of senders after approval is received.

### FIELD

The present disclosure relates to e-mail drafting from multiple senders.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

E-mail programs are typically designed to have one sender and one or more recipients. However, it is common for multiple people to have input on an e-mail message. Currently, this is accomplished by multiple people discussing the content of the e-mail and drafting an e-mail from a single account. This may create inefficiencies and may also result in a recipient not being aware that multiple people had input into the e-mail.

### SUMMARY

In various embodiments of the present disclosure, a collaborative e-mail technique can include receiving, at a computing device in communication with a network, a collaborative e-mail request from a first one of a plurality of senders at a server. A draft of a collaborative e-mail can be stored at a database in communication with the computing device. The plurality of senders can be notified of the collaborative e-mail request via the computing device and can be provided access to the draft.

Revisions to the draft can be received from multiple ones of the plurality of senders and approval of the draft can be received from the plurality of senders at the computing device. The collaborative e-mail can be sent, via the computing device, to a recipient from the plurality of senders after receiving approval. The sending can include the collaborative e-mail being automatically sent to the recipient from the plurality of senders once approval is received from each of the plurality of senders and can include providing an indication of the plurality of senders in a from-field of the collaborative e-mail.

In various embodiments of the present disclosure, a collaborative e-mail technique can include receiving, at a computing device in communication with a network, a collaborative e-mail request for a plurality of senders. A draft of a collaborative e-mail can be stored at a database in communication with the computing device. The plurality of senders can be notified of the collaborative e-mail request and can be provided access to the draft via the computing device. Approval of the draft can be received from the plurality of senders at the computing device and the collaborative e-mail can be sent, via the computing device, to a recipient from the plurality of senders after approval is received.

In various embodiments of the present disclosure, a collaborative e-mail technique can include a computing device having a collaborative e-mail request module, a collaborative e-mail generation module, a collaborative e-mail notification module and a collaborative e-mail access module and a database. The collaborative e-mail request module can receive a collaborative e-mail request for a plurality of senders. The collaborative e-mail generation module can be in communication with the collaborative e-mail request module and can generate a draft of a collaborative e-mail. The database can be in communication with the collaborative e-mail generation module and can store the draft. The collaborative e-mail notification module can be in communication with the collaborative e-mail request module and can notify the plurality of senders of the collaborative e-mail request. The collaborative e-mail access module can be in communication with the collaborative e-mail notification module, the collaborative e-mail generation module and the database. The collaborative e-mail access module can provide the plurality of senders access to the draft and receive approval of the draft from each of the plurality of senders. The collaborative e-mail generation module can send the collaborative e-mail to a recipient from the plurality of senders after receiving approval from each of the plurality of senders.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic diagram of an example environment in which techniques of the present disclosure can be utilized;

FIG. 2 is a functional block diagram of an example computing device from FIG. 1;

FIG. 3 is a flow diagram of an example e-mail technique according to the present disclosure; and

FIG. 4 is a schematic illustration of a screenshot of an example inbox according to the present disclosure.

### DETAILED DESCRIPTION

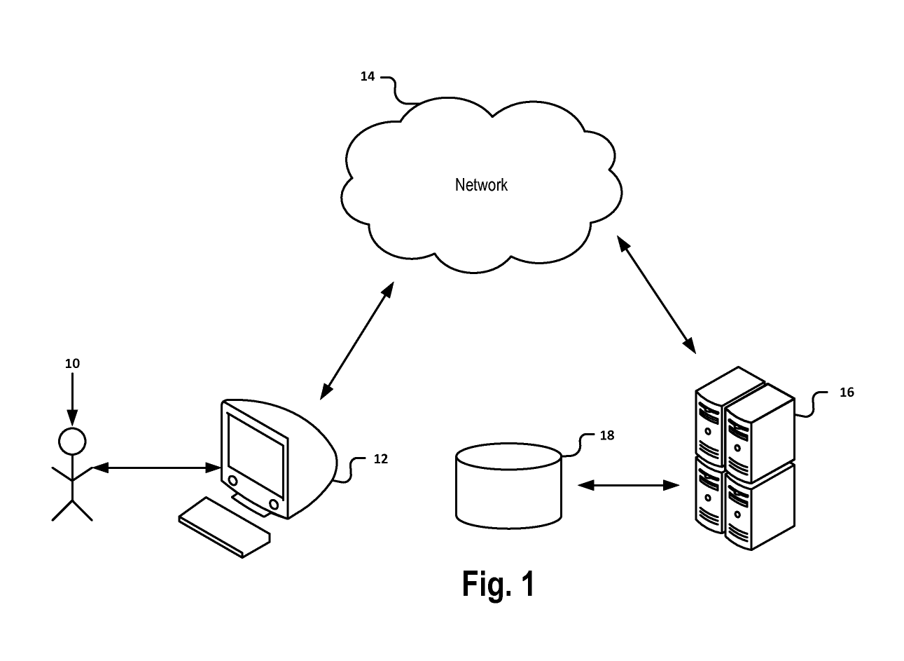

Referring now to FIG. 1, an environment in which the techniques according to some embodiments of the present disclosure can be utilized is illustrated. A user 10 can interact with a user device 12, for example, to access a network 14. Examples of the network 14 include, but are not limited to, the Internet, a wide area network, a local area network, and a private network. A computing device 16 may be connected to the network 14 and may be in communication with a database 18 and may also be accessed by the user 10 via the user device 12. By way of non-limiting example, the interaction between the user device 12 and the computing device 16 may be provided by a variety of programming languages including, but not limited to, a JavaScript interface.

As used in the present disclosure, a computing device may include one or more servers and/or processors. One skilled in the art will appreciate that the environment shown in FIG. 1 is merely illustrative and different environments (such as those that include more or less components, those that include additional connections, and/or those that are arranged in a different configuration) may be utilized with the present disclosure.

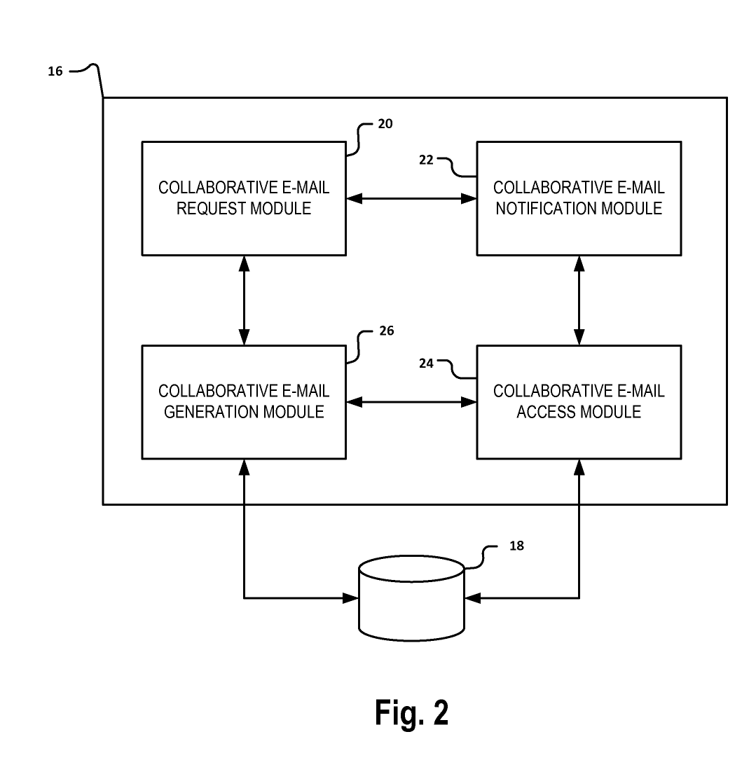

With reference to FIG. 2, the computing device 16 may be in the form of an electronic mail (e-mail) server and may include a collaborative e-mail request module 20, a collaborative e-mail notification module 22, a collaborative e-mail access module 24 and a collaborative e-mail generation module 26. The collaborative e-mail request module 20 may be in communication with the collaborative e-mail notification module 22 and the collaborative e-mail generation module 26. The collaborative e-mail notification module 22 may additionally be in communication with the collaborative e-mail access module 24. The collaborative e-mail access module 24 and the collaborative e-mail generation module 26 may be in communication with one another and with the database 18.

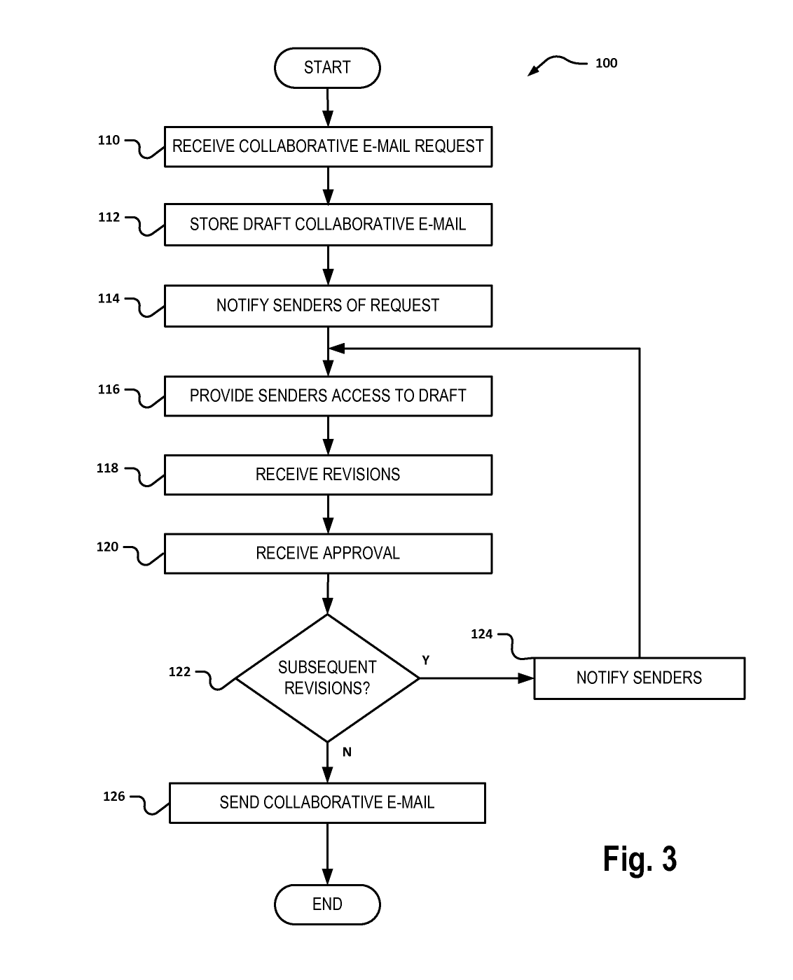

The collaborative e-mail technique 100 is illustrated in the flow chart shown in FIG. 3. At 110, a collaborative e-mail request may be received at the collaborative e-mail request module 20. The collaborative e-mail request may initiate a collaborative e-mail from a plurality of senders. The plurality of senders may include a group of individuals that will have input into the content of the e-mail and be identified as senders of the e-mail.

The collaborative e-mail request may be generated by a first one of the plurality of senders. A sender may initiate the collaborative e-mail in a variety of ways. Alternatively, a collaborative e-mail may automatically be initiated based on a user group. For purposes of illustration only, a collaborative e-mail from a management group to employees may be generated automatically based on a meeting discussing information to be presented to the employees. A draft of the collaborative e-mail may be generated by the collaborative e-mail generation module 26 and may be stored in the database 18 at 112. The draft may include an empty e-mail (no content) or may include a first draft of an e-mail from one of the senders including initial content for the other senders to add to or revise.

At 114, the plurality of senders may be notified of the collaborative e-mail by the collaborative e-mail notification module 22. The plurality of senders may be notified in a variety of ways including, but not limited to, an e-mail notification. At 116, the plurality of senders may be provided access to the draft of the collaborative e-mail via the collaborative e-mail access module 24.

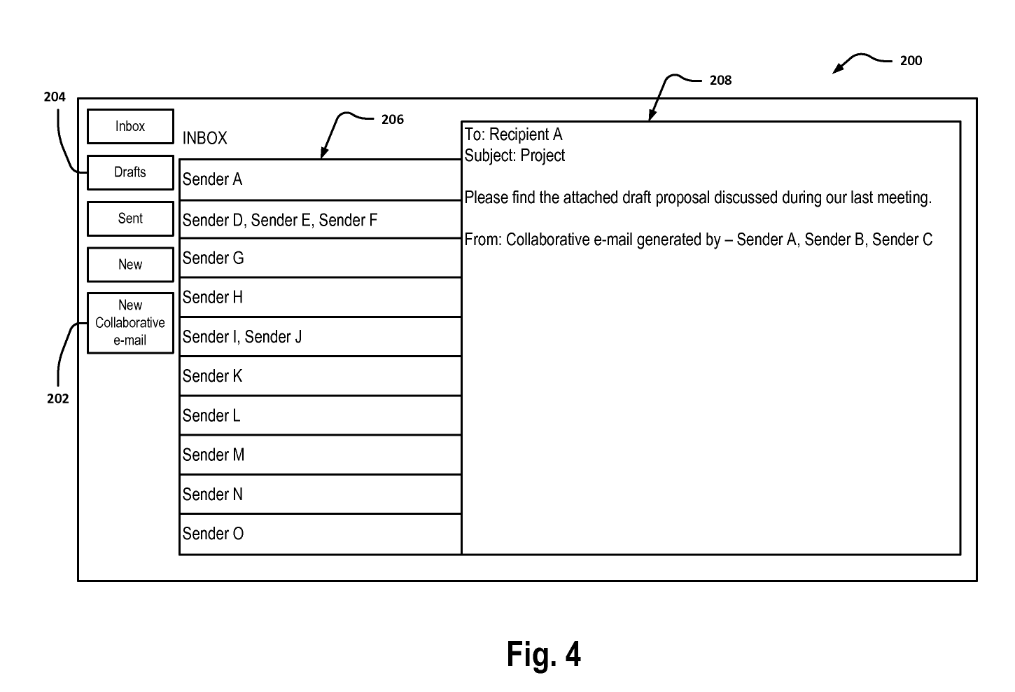

A screenshot of an example mailbox 200 is schematically illustrated in FIG. 4. By way of non-limiting example, an option may exist in a user's mailbox for new collaborative e-mail 202. The draft may appear in the mailbox 200, seen in FIG. 4, of each of the senders under the drafts 204. The draft of the collaborative e-mail in each of the sender's drafts 204 may be a shortcut to the document stored on the database 18.

The collaborative e-mail access module 24 may receive revisions to the draft from one or more of the plurality of senders. The senders may revise any field of the draft including, but not limited to, recipients, subject, text in the body of the draft and attachments. Each of the senders may have access to the draft simultaneously and may be able to view and revise the draft in real-time with other ones of the senders. As mentioned above, the collaborative e-mail draft may be stored in the database 18. Each sender (such as user 10) can access the collaborative e-mail draft in the database 18 via a user device (such as user device 12) in communication with the network 14. As the user 10 edits (adds to, deletes from, etc.) the collaborative e-mail draft by interacting with the user device 12, the database 18 can be updated such that any and all senders can see the present version of the collaborative e-mail draft. In this manner, each of the senders can access, edit and/or approve of a single version of the collaborative e-mail draft.

Once a sender is satisfied with the content of the draft, the sender may approve the draft. Approval of the draft may be provided by the sender in a variety of ways including, but not limited to, pressing a “send” button. The collaborative e-mail access module 24 may receive the approval at 120 and provide the approval to the collaborative e-mail generation module 26. The remaining senders may be notified of the approval from each of the senders in a variety of ways including, but not limited to, an e-mail notification of the approval by a sender. Alternatively, the remaining senders may not be notified of the approval from each of the senders and the e-mail may be sent after approval is received from all of the senders without providing an updated status as senders approve the draft.

At 122, it may be determined when a first sender has approved the draft and a second sender has subsequently revised the draft. At 124, the first sender may be notified when the second sender has revised the draft subsequent to the approval from the first sender via the collaborative e-mail notification module 22 and the technique 100 may return to 116. At 116, the collaborative e-mail access module 24 may again provide the opportunity for the first sender to revise and/or approve the draft again. The first sender may alternatively select not to be notified of subsequent revisions and simply indicate a final approval without regard to subsequent revisions.

After each of the senders has approved the draft, the technique 100 may proceed to 126 where the collaborative e-mail generation module 26 sends the collaborative e-mail to the recipients. The collaborative e-mail may be automatically sent by the collaborative e-mail generation module 26 after approval is received from each of the plurality of senders.

Generating a collaborative e-mail from multiple senders allows for multiple senders to edit and approve the content of an e-mail in a common draft of the e-mail. The collaborative e-mail technique also provides for notification to a recipient that the e-mail is the product of input from the plurality of senders. As seen in FIG. 4, the from-field 206 in an e-mail or inbox may be expanded to indicate the plurality of senders, such as “Sender D, Sender E, Sender F” or “Sender I, Sender J”. Alternatively, if identifying multiple senders in the from-field is not supported by a recipient e-mail client, the plurality of senders may be identified in the text of the message 208 seen in FIG. 4, such as “Collaborative e-mail generated by—Sender A, Sender B, Sender C”. In either example, the collaborative e-mail technique provides some form of notification to the recipients of the creation of the e-mail by multiple senders.

The collaborative e-mail technique may also be applied to multiple recipients of an e-mail (whether the original e-mail was from a single sender or from multiple senders). When responding to an e-mail including multiple recipients, the reply from the multiple recipients allows for the multiple recipients to function as the multiple senders discussed above, providing the ability to edit and approve the content of a reply e-mail in a common draft of the e-mail.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A computer-implemented method comprising:
receiving, at a server having one or more processors, a collaborative e-mail request from a first computing device associated with a first sender of a plurality of senders, the collaborative e-mail request being automatically generated by the first computing device in response to the first sender specifying the plurality of senders and at least one recipient for a draft collaborative e-mail;
storing, at the server, the draft collaborative e-mail;
in response to receiving the collaborative e-mail request, automatically notifying, by the server, a remainder of the plurality of senders of the draft collaborative e-mail at respective computing devices;
providing, by the server, the plurality of senders access to the draft collaborative e-mail via their respective computing devices;
receiving, at the server, real-time revisions to the draft collaborative e-mail from multiple ones of the plurality of senders simultaneously via their respective computing devices to obtain a revised draft collaborative e-mail;
receiving, at the server, approval of the revised draft collaborative e-mail from each of the plurality of senders to obtain an approved collaborative e-mail;
in response to obtaining the approved collaborative e-mail, automatically sending, from the server, the approved collaborative e-mail to the at least one recipient.

2. A computer-implemented method comprising:
receiving, at a server having one or more processors, a collaborative e-mail request from a first computing device associated with a first sender of a plurality of senders, the collaborative e-mail request being automatically generated by the first computing device in response to the first sender specifying the plurality of senders and at least one recipient for a draft collaborative e-mail;
storing, at the server, the draft collaborative e-mail;
in response to receiving the collaborative e-mail request, automatically notifying, by the server, a remainder of the plurality of senders of the draft collaborative e-mail at respective computing devices;
providing, by the server, the plurality of senders access to the draft collaborative e-mail via their respective computing devices;
receiving, at the server, real-time revisions to the draft collaborative e-mail from multiple ones of the plurality of senders via their respective computing devices to obtain a revised draft collaborative e-mail;
receiving, at the server, approval of the revised draft collaborative e-mail from each of the plurality of senders to obtain an approved collaborative e-mail; and
in response to obtaining the approved collaborative e-mail, automatically sending, by the server, the approved collaborative e-mail to the at least one recipient.

3. (canceled)

4. The computer-implemented method of claim 2, wherein the real-time revisions are made to the draft collaborative e-mail by the multiple ones of the plurality of senders via their respective computing devices while being viewed simultaneously by a second remainder of the plurality of senders via their respective computing devices.

5. The computer-implemented method of claim 2, wherein sending the approved collaborative e-mail includes providing an indication of the plurality of senders in a from-field of the approved collaborative e-mail.

6. The computer-implemented method of claim 2, wherein sending the approved collaborative e-mail includes providing an indication of the plurality of senders in a body of the approved collaborative e-mail.

7. The computer-implemented method of claim 2, wherein notifying the first remainder plurality of senders of the draft collaborative e-mail includes providing, by the server, an e-mail to each of the first remainder of the plurality of senders indicating that the draft collaborative e-mail has been initiated by the first sender of the plurality of senders.

8. The computer-implemented method of claim 7, wherein providing the plurality of senders access to the draft collaborative e-mail includes each of the plurality of senders having access to a shared version of the draft collaborative e-mail through a drafts portion of each sender's mailbox.

9. (canceled)

10. The computer-implemented method of claim 2, further comprising, when the server receives approval of the revised draft collaborative e-mail from a second sender of the plurality of senders and subsequently receives a revision to the revised draft collaborative e-mail from a third sender of the plurality of senders, notifying, by the server, the second sender of a revised status of the revised draft collaborative e-mail.

11. The computer-implemented method of claim 10, further comprising providing, by the server, an additional opportunity for the second sender to approve the revision by the third sender to the revised draft collaborative e-mail before the approved collaborative e-mail is automatically sent to the at least one recipient.

12. A server having one or more processors configured to perform operations comprising:
receiving a collaborative e-mail request from a first computing device associated with a first sender of a plurality of senders, the collaborative e-mail request being automatically generated by the first computing device in response to the first sender specifying the plurality of senders and at least one recipient for a draft collaborative e-mail;
generating the draft collaborative e-mail based on input from the first sender via the first computing device;
storing the draft collaborative e-mail;
in response to receiving the collaborative e-mail request, automatically notifying other computing devices associated with a first remainder of the plurality of senders of the draft collaborative e-mail;
providing each of the plurality of senders access to the draft collaborative e-mail;
receiving real-time revisions to the draft collaborative e-mail from multiple ones of the plurality of senders via their respective computing devices to obtain a revised draft collaborative e-mail;
receiving approval of the revised draft collaborative e-mail from each of the plurality of senders via their respective computing devices to obtain an approved collaborative e-mail; and
in response to obtaining the approved collaborative e-mail, automatically sending the approved collaborative e-mail to the at least one recipient.

13. (canceled)

14. The server of claim 12, wherein sending the approved collaborative e-mail includes providing an indication of the plurality of senders in a from-field of the approved collaborative e-mail.

15. The server of claim 12, wherein sending the approved collaborative e-mail includes providing an indication of the plurality of senders in a body of the approved collaborative e-mail.

16. The server of claim 12, wherein notifying the first remainder of the plurality of senders of the draft collaborative e-mail includes providing an e-mail to each of the first remainder of the plurality of senders indicating that the draft collaborative e-mail has been initiated by the first sender of the plurality of senders.

17. The server of claim 16, wherein providing each of the plurality of senders access to the draft collaborative e-mail includes providing each of the plurality of senders access to a shared version of the draft collaborative e-mail through a drafts portion of each senders' mailbox.

18. (canceled)

19. The server of claim 12, wherein the operations further comprise notifying a second sender of the plurality of senders of a revised status of the revised draft collaborative e-mail when approval of the revised draft collaborative e-mail is received from the second sender and a revision to the revised draft collaborative e-mail is subsequently received from a third sender of the plurality of senders.

20. The server of claim 19, wherein the operations further comprise providing an additional opportunity for the second sender to approve the revision to the revised draft collaborative e-mail before the approved collaborative e-mail is automatically sent to the at least one recipient.

21. The computer-implemented method of claim 2, wherein the multiple ones of the plurality of senders that provided revisions to obtain the revised draft collaborative e-mail are notified, by the server, via e-mail when a second remainder of the plurality of senders have approved the revised draft collaborative e-mail.

22. The server of claim 12, wherein the operations further comprise notifying the multiple ones of the plurality of senders that provided revisions to obtain the revised draft collaborative e-mail via e-mail when a second remainder of the plurality of senders have approved the revised draft collaborative e-mail.

23. The computer-implemented method of claim 2, wherein the real-time revisions to the draft collaborative e-mail are received simultaneously from multiple ones of the plurality of senders via their respective computing devices.

24. The server of claim 12, wherein the real-time revisions to the draft collaborative e-mail are received simultaneously from multiple ones of the plurality of senders via their respective computing devices.
